(19) United States
(12) Patent Application Publication
(10) Pub. No.: US 2010/0129128 A1
(43) Pub. Date: May 27, 2010

(54) Bookbinding apparatus and image forming system

(75) Inventor: Tsuyoshi Tsuchiya, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA BUSINESS TECHNOLGIES, INC., Tokyo (JP)

(21) Appl. No.: 12/592,045

(22) Filed: Nov. 18, 2009

(30) Foreign Application Priority Data
Nov. 27, 2008 (JP) JP2008-302189

(51) Int. Cl. G03G 15/00; B42C 9/00; B42C 19/00

(52) U.S. Cl. 399/408; 412/37

(57) ABSTRACT

A bookbinding apparatus, which applies adhesive onto a back of a bundle of sheets and forms a booklet, comprising: an adhesive tank which is configured to store the adhesive; a heating section which is configured to heat and melt the adhesive stored in the adhesive tank; an adhesive supplying member which is configured to be submerged in the adhesive stored in the adhesive tank, and to be rotated to supply the adhesive onto the back of the bundle of sheets; and a control section which controls the heating section to heat the adhesive to a predetermined coating temperature as a warm-up process, and to control the adhesive supplying member to rotate during the warm-up process.

### CROSS REFERENCE TO RELATED APPLICATION

This application is based on Japanese Patent Application No. 2008-302,189 filed on Nov. 27, 2008, with the Japanese Patent Office, the entire content of which is hereby incorporated by reference.

### TECHNICAL FIELD

The present invention relates to a bookbinding apparatus and an image forming system using the same apparatus.

The above image forming system includes an image forming apparatus which forms an image on a recording sheet, and includes a bookbinding apparatus which receives the recording sheet, on which the image has been formed by the image forming apparatus, from the image forming apparatus, and conducts a bookbinding process onto the recording sheet.

### BACKGROUND OF THE INVENTION

In printing fields, referred to as a POD (being print on demand), books are produced by the image forming system, structured of the image forming apparatus and the bookbinding apparatus, while printing plates are not formed.

Most of the bookbinding apparatus for the POD, as disclosed in Unexamined Japanese Patent Application Publication No. 2008-80,603 (hereinafter referred to as “Patent Document 1”), in order to bind a bundle of sheets (hereinafter referred to as a “sheet-bundle”), an adhesive applying device is used. Since the adhesive applying device is simply structured, and small-sized, said device is suitable to combine with the image forming apparatus.

Regarding above Patent Document 1, in an adhesive coating device, including an adhesive container heater and a coating section heater, after a temperature of the adhesive container heater, a temperature of the coating section heater, and a temperature of the adhesive have been individually detected, the adhesive container heater and the coating section heater are individually controlled, whereby the temperature of the adhesive in the container is controlled to a uniform temperature, and the adhesive is quickly melted.

In Unexamined Japanese Patent Application Publication No. H10-35,138 (hereinafter referred to as “Patent Document 2”), the number of heaters is configured to differ in a warm-up time and a coating time, so that the warm-up time is shortened and electrical energy consumption is minimized.

As above Patent Document 2 discloses, the waiting time must be reduced, which time is between a starting time of the adhesive heating section and a time in which a coating operation can be conducted, in which the adhesive has been melted, that is, reduction of said waiting time has been a great technical matter to be solved.

The waiting time is a warm-up time to heat the adhesive to a temperature in which a coating operation can be conducted, after the adhesive heating section has been activated. In Patent Documents 1 and 2, a plurality of heaters, used as a heating means, are individually controlled, so that the warm up time may be reduced.

However, the above described methods to reduce the warm-up time have their own limitations, whereby the warm-up time cannot be sufficiently reduced. Further, like Patent Document 2, if a heater, which is activated only during the warm-up time, is employed, the electrical energy consumption is increased during the warm-up time, whereby maximum electrical power of the apparatus cannot but increase.

### SUMMARY OF THE INVENTION

An aspect of the present invention is detailed below. A bookbinding apparatus, which binds a bundle of sheets with an adhesive, and forms a booklet, including:

an adhesive tank which is configured to store the adhesive;

a heating section to heat and melt the adhesive stored in the adhesive tank;

an adhesive supplying member which is configured to be submerged in the adhesive stored in the adhesive tank, and to be rotated to supply the adhesive onto a coating portion of the bundle of sheets; and

a control section which controls the adhesive supplying member to rotate, in at least one interval during a warm-up process in which the adhesive is heated to a predetermined temperature by the heating section after the heating section has been activated.

According to the above aspect, another aspect is an image forming system, including:

an image forming apparatus which is configured to form an image on a sheet; and

the bookbinding apparatus described in the above aspect.

### BRIEF DESCRIPTION OF THE DRAWINGS

Embodiment will now be described, by way of example only, with reference to the accompanying drawings which are meant to be exemplary, not limiting, and wherein like elements are numbered alike in the several figures, in which:

FIG. 1 shows a total structure of an image forming system relating to the embodiment of the present invention;

FIG. 2 shows a cross-sectional view of a bookbinding apparatus relating to the embodiment of the present invention;

FIG. 3 shows a structure of adhesive coating section 50;

FIG. 4 shows roller heater H2 coupling to adhesive coating roller 51;

FIG. 5 is a block diagram of a control system to heat the adhesive in the bookbinding apparatus relating to the embodiment of the present invention;

FIG. 6 is a flow chart to detail a heating procedure of the adhesive, and

FIG. 7a shows the change of the temperature of adhesive during the warm-up time, controlled by the conventional art, and

FIG. 7b shows the change of the temperature of adhesive during the warm-up time, controlled by the present invention.

### DETAILED DESCRIPTIONS OF THE PREFERRED EMBODIMENTS

Embodiments of the present invention will now be detailed while referring to the drawings, but the present invention is not limited to the embodiment.

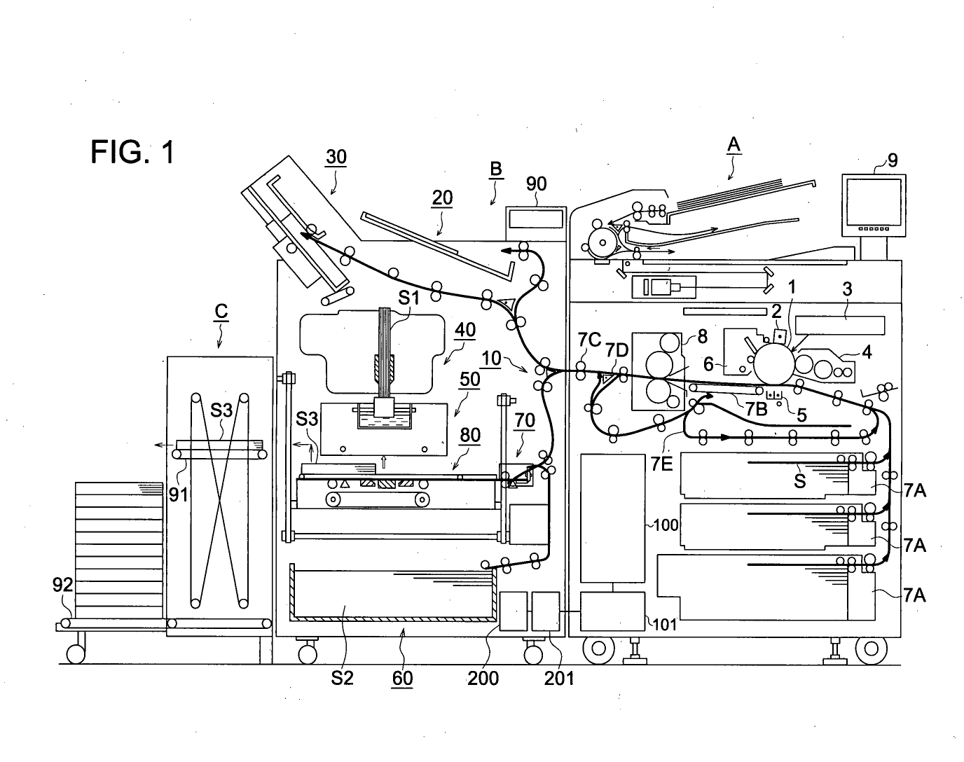

FIG. 1 shows a total structure of an image forming system relating to the embodiment of the present invention.

The image forming system shown in FIG. 1 includes image forming apparatus A and bookbinding apparatus B. In the present embodiment, bound booklet storing apparatus C follows bookbinding apparatus B. After booklet storing apparatus C receives bound booklet S3, formed by bookbinding apparatus B, booklet storing apparatus C conveys bound booklet S3 using belt 91, and stores it on wheeled platform 92.

### <Image Forming Apparatus A>

Image Forming Apparatus A to form an image using an electro-photographic process includes an image forming section, in which electrical charging section 2, image exposure section 3, developing section 4, image transfer and discharging section 5, and cleaning section 6, are arranged around rotating photoconductor 1.

The image forming section evenly applies an electrostatic charge onto a surface of photoconductor 1. After that, the image forming section conducts exposure scanning, based on targeted image data, using laser beams emitted from image exposure section 3, and forms a latent image. Subsequently, the image forming section conducts reversal development for the latent image using developing section 4, whereby a toner image is formed on the surface of photoconductor 1.

Recording sheet S, which is supplied from sheet storing section 7A, is conveyed to a transfer position. At said position, the targeted toner image is transferred onto recording sheet S by transfer and discharging section 5. After that, any electrical charges remaining on recording sheet S are eliminated, and recording sheet S is then separated from photoconductor 1. Said image carrying recording sheet S is conveyed to fixing section 8 by conveyance section 7B, at which, said recording sheet S is heated to fix the image, and sheet S is then ejected to bookbinding apparatus B, by ejection roller 7C.

To form images on both surfaces of recording sheet S, recording sheet S, carrying one image fixed by fixing section 8, is conveyed by conveyance path switching section 7, to a conveyance path, which is branched from a normal ejection path. Recording sheet S is then switched back by reversing conveyance section 7E, so that recording sheet S is reversed by the switch-back movement, subsequently said recording sheet S is re-conveyed to the above described transfer position, whereby, a new image is formed on the reverse surface of recording sheet S.

Recording sheet S, carrying the two images fixed by fixing section 8 on both of its surfaces, is ejected to the outside of the apparatus through paired ejection rollers 7C. Said recording sheet S is then conveyed to bookbinding apparatus B.

After the image formation, any remaining toner particles are removed from the surface of photoconductor 1, by cleaning section 6, and photoconductor 1 stands by for next image formation.

Operation display section 9, including an input section and a display section, is provided on an upper section of image forming apparatus A.

### <Bookbinding Apparatus B>

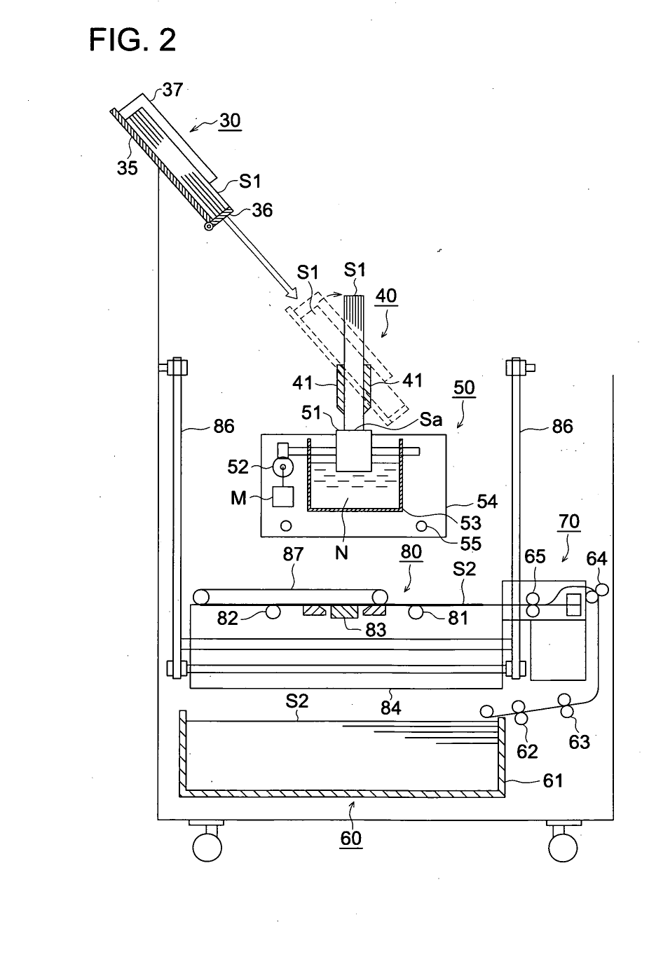

Bookbinding apparatus B will now be detailed while referring to FIGS. 1 and 2. FIG. 1 shows a cross-sectional structure of bookbinding apparatus B.

Bookbinding apparatus B is structured of sheet conveyance section 10, sheet storage section 20, sheet-bundle storing section 30, sheet-bundle conveyance section 40, adhesive coating section 50, cover sheet supplying section 60, cover sheet cutting section 70, cover sheet supporting section 80, and operation display section 90.

Sheet S, which has been conveyed from image forming apparatus A to sheet conveyance section 10, is further conveyed to any one of sheet storage section 20, sheet-bundle storing section 30, and cover sheet supporting section 80, by plural sets of conveyance rollers, and a conveyance path switching gate. If no bookbinding process has been ordered, the conveyance path switching section is determined to be a non-bookbinding operation, whereby sheets S, conveyed from image forming apparatus A, are sequentially ejected onto a sheet storage tray of sheet storage section 20.

If a bookbinding process has been ordered by the user, sheet S, on which a fixed image has been formed by image forming apparatus A, is conveyed by sheet conveyance section 10, to sheet-bundle storing section 30, that is, plural sheets S are subsequently stacked on sheet-bundle storing section 30, whereby said stacked sheets are jogged to become sheet-bundle S1.

Sheet-bundle S1 is conveyed by sheet-bundle conveyance section 40, after that, adhesive is applied onto back Sa of sheet-bundle S1 by adhesive coating section 50, wherein back Sa serves as a coating portion.

Onto back Sa of sheet-bundle S1, on which adhesive has been already applied, cover sheet S2 is placed, while being supported by cover sheet supporting section 80. After that, cover sheet S1 is folded along both edges of back Sa, whereby booklet S3 is produced.

Sheet-bundle storing section 30 includes sheet stacker 35, which is slanted, movable trailing edge positioning member 36, alignment member 37, which aligns all sheets of sheet-bundle S1 with respect to the width of sheet-bundle S1, and the like members.

Sheets S, which have been conveyed by sheet conveyance section 10 from image forming apparatus A, are subsequently placed on sheet stacker 35. After a predetermined number of sheets S are stocked, sheet-bundle S1 is formed.

After sheet-bundle S1 has been jogged and aligned on sheet stacker 35 of sheet-bundle storing section 30, sheet-bundle S1 is nipped by opposed nipping sections 41. After that, trailing edge positioning member 36 is retracted under sheet stacker 35 by a driving section, which is not illustrated.

After opposed nipping sections 41 have nipped sheet-bundle S1, said sections 41 move downward obliquely, as shown by dotted lines in FIG. 2. Subsequently, opposed nipping sections 41 turn vertically, whereby back Sa of sheet-bundle S1 is turned with the back downward, and opposed nipping sections 41 stop at this position, being a predetermined position.

A cover sheet S2, which has been stored in cover sheet accommodating section 61 of cover sheet supplying section 60, is picked and conveyed by sheet supplying section 62 through paired conveyance rollers 63, 64 and 65, and then further conveyed by conveyance rollers 81 and 82 of cover sheet supporting section 80, to a predetermined position, where cover sheet S2 stops.

If the length of cover sheet S2 is greater than the length to conduct a case binding of sheet-bundle S1, cover sheet S2 is cut by cover sheet cutting section 70, which is located at the right of conveyance roller 65 in FIG. 2, so that an extra portion of cover sheet S2 is removed in advance.

Adhesive coating section 50 is provided on movable body 54, which is supported by guiding rods 55, whereby adhesive coating section 50 moves perpendicularly on the page surface of FIG. 2. Since a home position of movable body 54 is provided in the rear of book binding device B, movable body 54 moves to the front, to conduct the adhering operation.

Adhesive coating roller 51, serving as an adhesive supplying member, is driven along back Sa of sheet-bundle S1 by motor M and driving system 52, that is, adhesive coating roller 51 moves perpendicularly on the page surface of FIG. 2.

Cover sheet supporting section 80 goes up and down by elevating section 86.

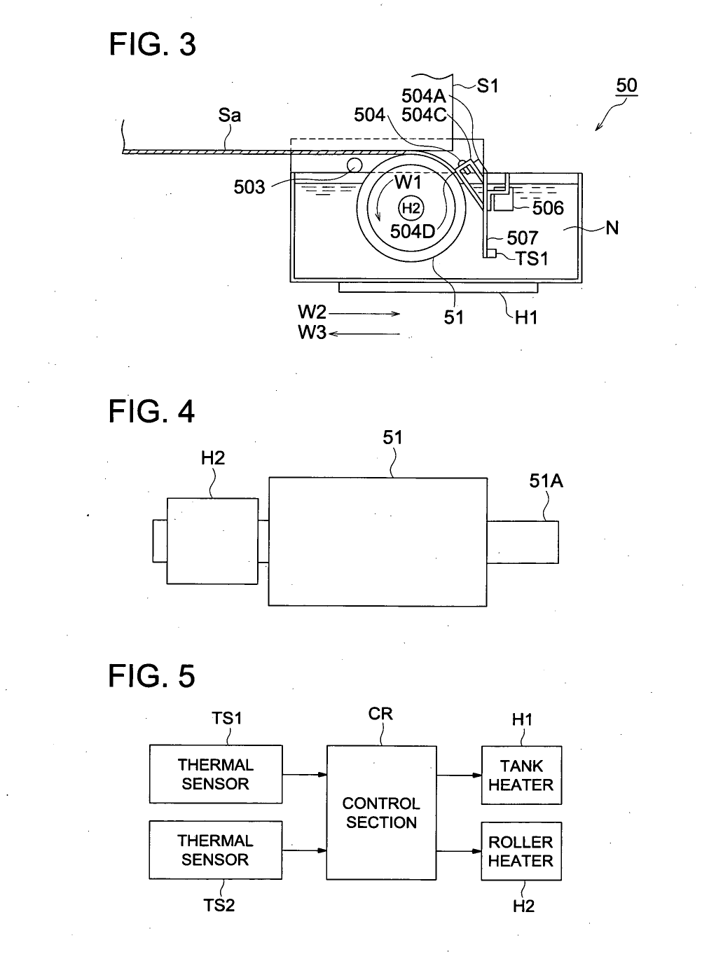

After movable body 54 has been driven forward from the home position to the front, adhesive coating roller 51 reciprocates in arrowed directions W2 and W3 (see FIG. 3, which will be detailed later), due to motor M, so that adhesive is coated onto back Sa of sheet-bundle S1.

After the coating operation has been finished, movable body 54 returns to the home position, and cover sheet supporting section 80 rises to adhere cover sheet S2 onto back Sa. Pressing section 83 is then driven to firmly press against back Sa.

Booklet S3, which has been formed by adhering cover sheet S2 onto sheet-bundle S1, is conveyed by belt 87 to booklet storing device C.

### <Adhesive Coating Section>

FIG. 3 shows adhesive coating section 50. Adhesive coating section 50 includes adhesive tank 53 to store melted liquid adhesive N, adhesive coating roller 51, serving as the adhesive supplying member, regulation members 503 and 504, tank heater H1, serving as a first heater to heat the adhesive, roller heater serving as a second heater to heat the adhesive, adhesive thermal sensor TS1, and remaining adhesive amount sensor 506.

In FIG. 3, the adhesive supplying member is structured of adhesive coating roller 51. However, an adhesive applying bar may also be used as another structure. A rotating adhesive supplying member supplies the adhesive onto said bar, that is, the adhesive coating member and the adhesive supplying member can be formed as different members.

Tank heater H1 is provided at the bottom portion of adhesive tank 53 as shown in FIG. 3, so that tank heater H1 heats the total adhesive in adhesive tank 53.

Roller heater H2 heats shaft 51A of adhesive coating roller 51, which is shown in FIG. 4. Shaft 51A is formed of metal, adhesive coating roller 51 is totally heated through shaft 51A, which is heated by roller heater H2, whereby the adhesive existing on adhesive coating roller 51 is heated.

Adhesive N, being in a pellet state, is supplied to adhesive tank 53 by a supplying device, which is not illustrated.

The adhesive in the pellet state is heated so that adhesive N is liquefied.

Based on signals sent from remaining adhesive amount sensor 506, adhesive N is supplied from the supplying device to adhesive tank 53, whereby a stable surface level of the liquid adhesive N is ensured.

Regulation member 503 is formed of a round rod, and regulation member 504 is mounted on supporting plate 507, that is, both ends of regulation member 504, being other than the coating area, are attached to supporting plate 507 by screws.

Regulation member 504 serves as a scraping section, which is structured of main scraping section 504A and sub-scraping section 504C, to scrape the adhesive, coated on back Sa of sheet-bundle S1 by adhesive coating roller 51, to a predetermined thickness.

Regulation member 504D controls the thickness of the adhesive layer on adhesive coating roller 51.

Regulation member 503, which is a rod member to control the thickness of the applied adhesive, is provided opposite above regulation member 504, with adhesive coating roller 51 in between.

Adhesive coating roller 51 is rotated in arrowed direction W1 by a motor, which is not illustrated, and reciprocates in arrowed directions W2 and W3 by motor M (see FIG. 2), so that adhesive coating roller 51 applies the adhesive onto back Sa of sheet-bundle S1, via the reciprocating movement.

During the movement in arrowed direction W2, the amount of adhesive on back Sa is controlled by regulation member 503, while during the movement in arrowed direction W3, the amount of adhesive on back Sa is controlled by regulation member 504, whereby the adhesive layer exhibiting the even thickness is formed on back Sa.

<Control during the Warm-up Procedure)

The warm-up time interval is typically several minutes to several tens of minutes, which is from the time when tank heater H1 is activated, to the time when adhesive N is completely melted as a coating state.

In order to improve the working efficiency of the bookbinding apparatus, the reduction of the warm-up time interval is one of the important problems for its development.

In the present invention, the adhesive is heated, while the adhesive supplying member is rotated, so that the temperature raising is speeded up, that is, the warm-up time interval can be decreased.

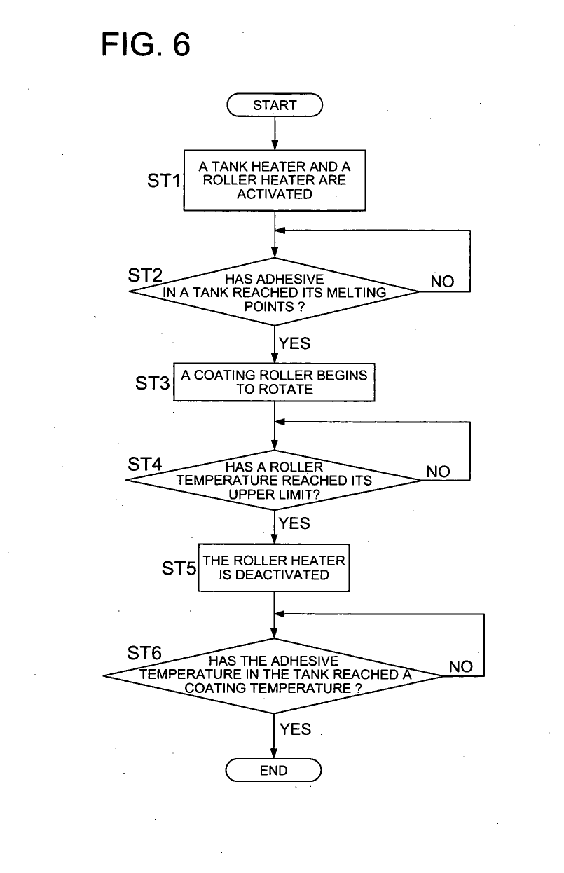

FIG. 5 is a block diagram of a control system to heat the adhesive in the bookbinding apparatus relating to the embodiments of the present invention, and FIG. 6 is a flow chart to detail a heating control procedure of the adhesive.

Control section CR conducts an ON-OFF control for tank heater H1 and roller heater H2, based on the output of thermal sensor TS1 to detect the temperature of the adhesive stored in adhesive tank 53, and based on the output of thermal sensor TS2 to detect the temperature of adhesive coating roller 51.

In this case, adhesive thermal sensor TS1, shown in FIG. 3, is submerged in adhesive N stored in adhesive tank 53, so that said sensor TS1 is able to continually detect the temperature of adhesive N. Further, adhesive thermal sensor TS2 is provided within adhesive coating roller 51, so that said sensor TS2 detects the operating temperature of the adhesive layer on adhesive coating roller 51.

In step ST1 of FIG. 6, tank heater H1 and roller heater H2 are electrically activated as a start of heating.

In step ST2, control section CR determines whether the temperature detected by adhesive thermal sensor TS1 has reached the melting point of the adhesive (for example, 90° C.), and if it has reached, the control to rotate adhesive coating roller 51 is started in step ST3.

Otherwise, the starting time of the control to rotate adhesive coating roller 51 may be after a predetermined time interval from “ON” of step ST1. Said predetermined time interval is experimentally determined to measure the time interval between the time of heater “ON” and the time when the adhesive temperature has reached its melting point.

If adhesive coating roller 51 is controlled to rotate before the temperature of the adhesive has reached its melting point, the motor to rotate adhesive coating roller 51 may become too load, which can adversely result in a damaged motor. Accordingly, until the temperature of the adhesive reaches its melting point, adhesive coating roller 51 is controlled not to rotate. After the melting point has been obtained, adhesive coating roller 51 is controlled to rotate, whereby adhesive coating roller 51 can rotate smoothly within melted adhesive N in adhesive tank 53.

The rotation control shown in step ST3 represents an intermittent control, in which adhesive coating roller 51 is controlled to rotate in 2-3 sec., and not to rotate in 2-3 sec., which control sequence is repeated.

Due to the rotation control of step ST3, adhesive N is desirably agitated in tank 53, for which reason, adhesive N has been heated evenly and quickly.

In step ST4, the temperature of adhesive coating roller 51 is monitored by adhesive thermal sensor TS2, whether the temperature is on an upper limit, or approaching it. If it is on the upper limit, roller heater H2 is deactivated. The upper limit of the temperature of adhesive coating roller 51 represents the highest temperature at which adhesive N does not change its inherent physical properties, said temperature is set at 185° C., for example.

When the temperature of adhesive coating roller 51 has reached the upper limit (“Yes” of step ST4), roller heater H2 is controlled to deactivate (step ST5). However, tank heater H1 is still activated.

In step ST6, the adhesive temperature, detected by adhesive thermal sensor TS1, is monitored whether it has reached the coating temperature.

The coating temperature is typically set, for example, at 165° C.

In step ST6, if the temperature of adhesive N, stored in adhesive tank 53, reaches the coating temperature, the warm-up procedure is completed.

After the completion of warm-up procedure, tank heater is controlled, which control is not illustrated in FIG. 6, to be “ON” and “OFF”, so that the temperature of adhesive N in adhesive tank 53 is kept to be the coating temperature.

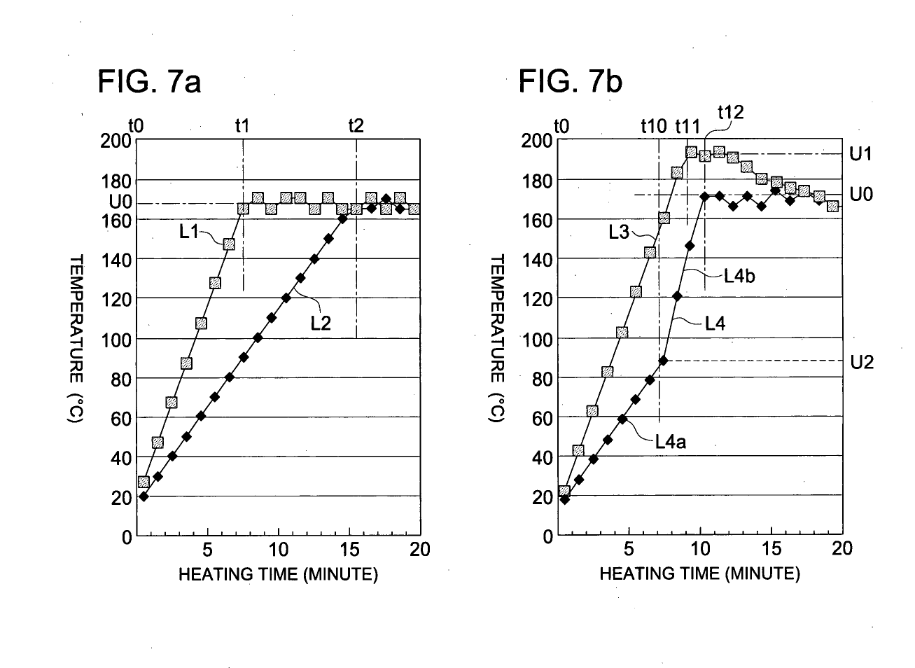

FIG. 7 shows the change of the temperature of adhesive N during the warm-up procedure.

FIG. 7a shows the change of the temperature of the adhesive, controlled by the conventional art, while FIG. 7b shows the changes of the temperature of the adhesive, controlled by the embodiment shown in the present invention.

The control, conducted by the conventional art, will now be detailed.

Adhesive coating roller 51 is controlled to deactivate, during the warm-up procedure of the conventional art. However, the tank heater and roller heater have also been used in the conventional art.

In FIG. 7a, tank heater H1 and roller heater H2 are controlled to start heating at time to.

Since the adhesive on adhesive coating roller 51 is heated by tank heater H1 and roller heater H2, an appreciation rate of the temperature of the adhesive on the coating roller is greater than that of the adhesive stored in adhesive tank 53, whereby the temperature of the adhesive on the coating roller quickly rises as shown in curve L1, which is like a straight line.

When the temperature of the adhesive on adhesive coating roller 51 has reached coating temperature U0 at time t1, roller heater H2 is controlled to change from continuous “ON” activation to continuous “ON and OFF” activation. Due to the “ON and OFF” control after time t1, the temperature of the adhesive on adhesive coating roller 51 is controlled to keep coating temperature U0.

On the other hand, the temperature of the adhesive in adhesive tank 53 rises slowly as shown by curve L2, and reaches coating temperature U0 at time t2.

After time t2, tank heater H1 is controlled to be “ON and OFF”, so that the temperature of the adhesive in adhesive tank 53 is kept to be coating temperature U0.

According to the present invention, tank heater H1 and roller heater H2 are activated to simultaneously start heating at time t0, which is shown in FIG. 7b.

Since the adhesive on adhesive coating roller 51 is heated by tank heater H1 and roller heater H2, an appreciation rate of temperature rise of the adhesive on adhesive coating roller 51 is greater than that of the adhesive stored in adhesive tank 53, whereby the temperature of the adhesive on the coating roller quickly rises as shown by curve L3, which is like a straight line.

When the temperature of the adhesive on adhesive coating roller 51 reaches upper limit temperature U1 at time t11, roller heater H2 is deactivated.

On the other hand, the temperature of the adhesive in adhesive tank 53 rises slowly as shown by line L4a, and reaches melting point U2 of the adhesive at time t10.

When the temperature of the adhesive in adhesive tank 53 reaches melting point U2 at time t10, the control to rotate adhesive coating roller 51 is started. That is, adhesive coating roller 51 is controlled to repeat “rotation” and “stop”, so that adhesive N in adhesive tank 53 is agitated.

Due to the agitation of adhesive N, the appreciation rate of temperature of adhesive in tank 53 becomes greater as shown by line L4b of curve L4.

When the temperature of the adhesive in tank 53 has reached coating temperature U0 at time t12, tank heater H1 is controlled to repeat “ON” and “OFF”. Due to the repeated “ON and OFF” control, the temperature of the adhesive within adhesive tank 53 is controlled to keep coating temperature U0.

As shown in FIG. 6, when adhesive thermal sensor TS1 has detected that the temperature of adhesive N in adhesive tank 53 has reached the coating temperature, the warm-up procedure is completed.

In FIG. 7b showing the embodiment of the present invention, the warm-up procedure is completed at time t12, which time is approximately 10 minutes after the start of warm-up.

However, in the conventional art shown in FIG. 7a, the warm-up time requires 15 minutes, which is longer than FIG. 7a.

The reduction of the warm-up time, shown in FIG. 7b, contributes to the rotation of adhesive coating roller 51, and yet contributes to the fact that roller heater H2 keeps the temperature of the adhesive on adhesive coating roller 51 at the upper limit temperature which is higher than the coating temperature.

That is, the overly heated adhesive on adhesive coating roller 51 is mixed with the lower temperature adhesive in adhesive tank 53, by the rotation of adhesive coating roller 51, whereby the temperature of adhesive N in adhesive tank 53 is more rapidly raised so that the warm-up time can be reduced.

Accordingly, due to the present invention, the warm-up time can be reduced considerably.

In the image forming system, the waiting time of image forming apparatus A is shorter than that of bookbinding apparatus B, whereby the total operational efficiency of the image forming system depends upon the waiting time of bookbinding apparatus B. By the present invention, since the waiting time of bookbinding apparatus B is reduced, the operational efficiency of the image forming system is considerably improved.

Concerning the effect of the invention, based on the present aspect, the adhesive in the adhesive tank is agitated during the warm-up procedure. Due to this agitation, the temperature distribution of the adhesive in the adhesive tank becomes more even, whereby the adhesive is more equally heated, so that the rising time of temperature of the adhesive in the tank is shortened, and the warm-up time can be reduced.

What is claimed is:

1. A bookbinding apparatus, which applies an adhesive onto a bundle of sheets and forms a booklet, comprising:
an adhesive tank which is configured to store the adhesive;
a heating section which is configured to heat and melt the adhesive stored in the adhesive tank;
an adhesive supplying member which is configured to be submerged in the adhesive stored in the adhesive tank, and to be rotated to supply the adhesive onto a coating portion; and
a control section which controls the adhesive supplying member to rotate, in at least one interval during a warm-up process in which the adhesive is heated to a predetermined temperature by the heating section after the heating section has been activated.

2. The bookbinding apparatus of claim 1, further comprising an adhesive thermal sensor which is configured to detect a temperature of the adhesive stored in the adhesive tank, wherein the control section controls the adhesive supplying member to rotate, based on the temperature detected by the adhesive thermal sensor.

3. The bookbinding apparatus of claim 2, wherein when the control section determines that the temperature of the adhesive in the adhesive tank, detected by the adhesive thermal sensor, has reached a melting point of the adhesive, the control section controls the adhesive supplying member to rotate.

4. The bookbinding apparatus of claim 1, wherein when a predetermined time has past after the heating section has been activated, the control section controls the adhesive supplying member to rotate.

5. The bookbinding apparatus of claim 1, wherein the control section controls the adhesive supplying member to repeat rotating operations and stopping operations.

6. The bookbinding apparatus of claim 1, wherein the adhesive supplying member comprises a coating roller to apply the adhesive onto the bundle of sheets.

7. The bookbinding apparatus of claim 1, wherein the heating section comprises a first heater which is provided at a bottom portion of the adhesive tank.

8. The bookbinding apparatus of claim 7, wherein the heating section further comprises a second heater which heats the adhesive supplying member.

9. The bookbinding apparatus of claim 2, wherein after the warm-up process has been completed, the control section repeatedly controls the heating section to activate and deactivate, based on the temperature detected by the adhesive thermal sensor, so that the adhesive temperature is kept at the coating temperature.

10. An image forming system, comprising:
an image forming apparatus to form an image on a recording sheet, and
a bookbinding apparatus, which binds a back of a bundle of sheets with an adhesive, and forms a booklet,
wherein the bookbinding apparatus comprises:
an adhesive tank which is configured to store the adhesive;
a heating section which is configured to heat and melt the adhesive stored in the tank;
an adhesive supplying member which is configured to be submerged in the adhesive stored in the adhesive tank, and to be rotated to supply the adhesive onto a coating portion; and
a control section which controls the adhesive supplying member to rotate, in at least one interval during a warm-up process in which the adhesive is heated to a predetermined temperature by the heating section after the heating section has been activated.
